(19) United States
(12) Patent Application Publication
(10) Pub. No.: US 2002/0171911 A1
(43) Pub. Date: Nov. 21, 2002

(54) Method for adjusting the hue of the light emitted by a light-emitting diode

(76) Inventor: Mamoru Maegawa, Kyoto-shi (JP)

Correspondence Address: David T. Nikaido, RADER, FISHMAN & GRAUER, PLLC, Suite 501, 1233 20th Street, NW, Washington, DC, 20036, US

(21) Appl. No.: 10/146,050

(22) Filed: May 16, 2002

(30) Foreign Application Priority Data
May 17, 2001 (JP) 2001-147718

(51) Int. Cl. G02F 1/33

(52) U.S. Cl. 359/308

(57) ABSTRACT

In a light-emitting diode, a phosphor layer 6 containing a phosphor is laid on top of translucent sealing resin 8 having a light-emitting diode element 3 sealed in it, and then, by shaving the phosphor layer 6, the hue of the light emitted by the light-emitting diode is adjusted. This makes it possible to adjust the hue of the light emitted by individual light-emitting diodes to obtain a uniform hue. For quick and easy adjustment of the hue, the phosphor layer 6 is shaved preferably by laser beam machining.

### BACKGROUND OF THE INVENTION

1. Field of the Invention

The present invention relates to a method for adjusting the hue of the light emitted by a light-emitting diode (hereinafter referred to also as an “LED”), and more particularly to a method for obtaining a uniform hue by reducing variations in the colors of the light emitted by individual LEDs.

2. Description of the Prior Art

One conventional way of producing a white LED is combining a blue LED with a phosphor based on yttrium-aluminum-garnet (YAG) or the like. Here, the light having wavelengths of 460 to 470 nm emitted by the blue LED is converted by the phosphor into light having a peak wavelength of 560 nm (yellowish green), and this light is mixed with the blue light that has passed through the layer of the phosphor to appear white to the human eye. FIG. 7 shows an example of a conventional LED of this type.

FIG. 7 is a sectional view of an LED in the form of a chip. A chip substrate 1 has a reflector case 5 fitted on the surface, and has an LED element 3 fixed substantially at the center. The electrodes of the LED element 3 are connected, through bonding wires 4, to terminal electrodes 2 and 2′ formed at both ends, left and right, of the chip substrate 1. Sealing resin 8, translucent and having a phosphor 7 dispersed in it, is poured into the reflector case 5 so as to seal the LED element 3 and the terminal electrodes 2 and 2′ arranged inside it.

In an LED like this, the phosphor 7 sediments before the sealing resin 8 hardens, and this makes it difficult to disperse the phosphor 7 uniformly in the sealing resin 8. Moreover, in the first place, it is difficult to obtain a phosphor of uniform composition due to causes inherent in its manufacturing process. As a result, LEDs exhibit variations in the hue of the light they emit.

### SUMMARY OF THE INVENTION

An object of the present invention is to provide a method for adjusting the hue of the light emitted by individual LEDs so as to reduce subtle variations among them and obtain a uniform hue.

Another object of the present invention is to provide a method for quickly and easily adjusting the hue of the light emitted by an LED.

To achieve the above objects, according to the present invention, a method for adjusting the hue of the light emitted by an LED includes the steps of: laying a phosphor layer containing a phosphor on top of a translucent sealing resin having an LED element sealed in it; and then adjusting the hue of the emitted light by shaving the phosphor layer. By this hue adjustment method according to the present invention, it is possible to adjust the hue of the light emitted by individual LEDs so as to reduce subtle variations among them and obtain a uniform hue.

Here, for quick and easy adjustment of the hue, the phosphor layer is shaved preferably by laser beam machining.

Moreover, the hue adjustment method according to the present invention is used particularly preferably to adjust the hue of the light emitted by a white LED. Here, the light-emitting diode is preferably based on GaN, and the phosphor is preferably based on YAG activated with cerium. Moreover, the phosphor layer has a thickness preferably in a range from 100 to 500 μm.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a process diagram showing an example of a hue adjustment method embodying the invention;

FIG. 2 is a perspective view of the sample LED used in Examples;

FIG. 3 is a chromaticity coordinates diagram showing the colors of the light emitted by the LED of Example 1;

FIG. 4 is a spectrum diagram showing the colors of the light emitted by the LED of Example 1;

FIG. 5 is a chromaticity coordinates diagram showing the colors of the light emitted by the LED of Example 2;

FIG. 6 is a spectrum diagram showing the colors of the light emitted by the LED of Example 2; and

FIG. 7 is a sectional view showing a conventional LED.

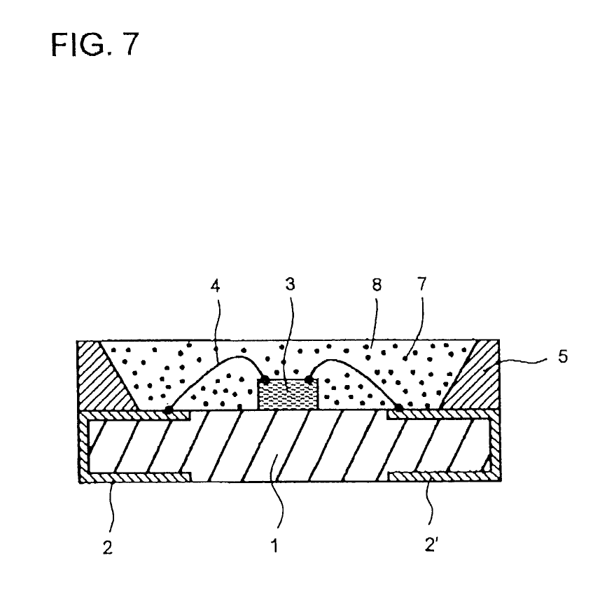

### DESCRIPTION OF THE PREFERRED EMBODIMENTS

As a result of an intensive study in search of as easy a method as possible for fine-adjusting the hue of the light emitted by an LED, which has traditionally been believed to be difficult, the inventor of the present invention has found out that, by first hardening sealing resin and then forming a phosphor layer containing a phosphor on top of it, it is possible to alleviate uneven dispersion of the phosphor due to its sedimenting, and moreover that, by shaving a very small portion off the phosphor layer, it is possible to fine-adjust the hue of the emitted light, which findings have led to the present invention.

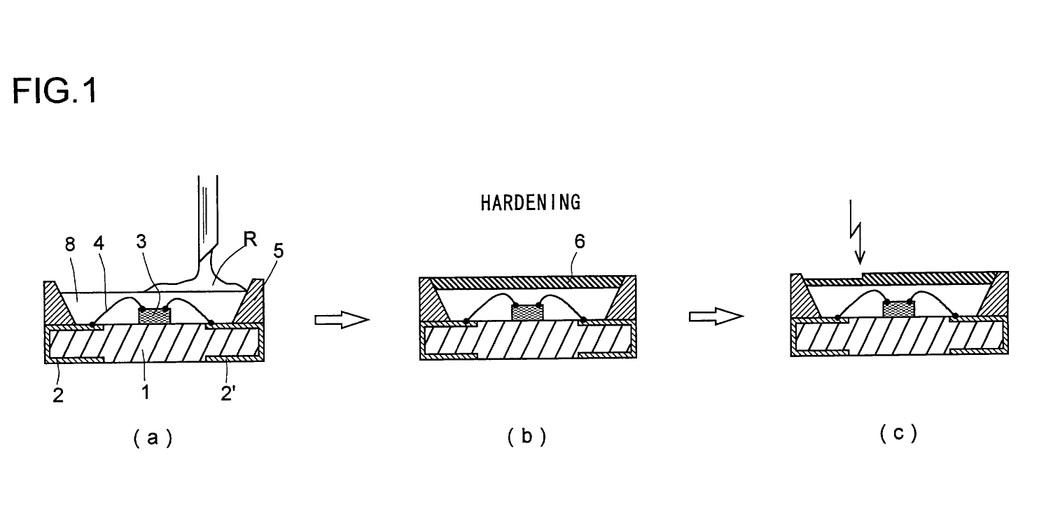

FIG. 1 is a process diagram showing an example of a hue adjustment method embodying the present invention. As shown at (a) in FIG. 1, on top of translucent sealing resin 8 having an LED element 3 sealed in it, translucent resin R containing a phosphor (not shown) is applied to form a phosphor layer 6. Since the phosphor layer 6 is smaller in volume than the translucent sealing resin 8, this helps alleviate uneven dispersion of the phosphor in the phosphor layer as compared with the conventional method, in which the phosphor is dispersed in the translucent sealing resin 8. In the figure, the translucent resin R is hardened after it is applied on top of the sealing resin 8. However, needless to say, it is also possible to lay the phosphor layer 6 on top of the sealing resin 8 by first forming the translucent resin R into a sheet and then bonding it on top of the sealing resin 8.

The phosphor layer may have any thickness, preferably in the range from 100 to 500 μm. A thickness smaller than 100 μm may pose restrictions on the shaving of the phosphor layer, which process will be described later. On the other hand, a thickness greater than 500 μm causes the sedimenting of the phosphor.

The translucent resin used here may be of any type as long as it is translucent, and it may be a resin similar to the sealing resin. Examples include epoxy resin, unsaturated polyester resin, silicone resin, and urea-melamine resin, among which epoxy resin is particularly preferred for its good translucency and other properties. The epoxy resin may be of any type as long as it has two or more epoxy groups per molecule and is intended for use as material for epoxy resin molding, examples including: epoxidized novolac resin of a phenol and an aldehyde, as represented by phenolic novolac type epoxy resin and ortho-cresol novolac type epoxy resin; diglycidyl ester type epoxy resin obtained through reaction with epichlorohydrin of a diglycidyl ether such as bisphenol A, bisphenol F, bisphenol S, or hydrogenated bisphenol A and a polybasic acid such as phthalic acid or dimer acid; glycidyl amine type epoxy resin obtained through reaction with epichlorohydrin of a polyamine such as diaminodiphenyl methane or isocyanuric acid; acyclic aliphatic epoxy resin obtained through oxidation of olefin linkage with a peracid such as peracetic acid; and alicyclic epoxy resin. These may be used singly or as a mixture of two or more of them. Preferably, any of these types of epoxy resin needs to be purified sufficiently and, irrespective of whether it is liquid or solid at ordinary temperature, appear as transparent as possible when liquefied.

The phosphor used may be of any known type, examples including organic phosphors such as allyl-sulfonamide/malemine-formaldelyde co-condensed dye and perylene-based phosphors; and inorganic phosphors such as aluminates, phosphates, and silicates. Among these, perylene-based phosphors and YAG-based phosphors are particularly preferred for their long service life. Examples of the activator used include elements such as cerium, europium, manganese, gadolinium, samarium, terbium, tin, and chromium. Among these, cerium is preferable. The preferred amount of the activator added is from 0.1 to 10 mol % of the amount of the phosphor. A preferred combination of the phosphor and the activator is YAG and cerium.

The content of the phosphor in the phosphor layer is determined appropriately according to the types of the LED element and of the phosphor. However, as will be described later, the hue of the emitted light is adjusted by shaving the phosphor layer, and therefore the phosphor needs to be added in an amount somewhat larger than usual. The preferred content is from 1 to 50% by weight.

In FIG. 1, after the phosphor layer 6 is hardened ((b) in FIG. 1), the hue of the light emitted by the LED is adjusted by shaving a portion off the phosphor layer 6. That is, the hue is adjusted by removing part of the phosphor contained in the phosphor layer ((c) in FIG. 1). Specifically, according to one method, the relationship between the amount of the portion of the phosphor layer shaved off and the change in the hue of the LED is studied beforehand, and then, for each LED, the hue is measured and a portion of the phosphor layer is shaved off of which the amount is determined from that relationship so as to yield the desired hue. According to another method, the phosphor layer is shaved while the hue of the LED is being measured. The latter method is preferred because it is easier to perform and offers higher accuracy.

The phosphor layer may be shaved by any known means. Examples include physical processes such as laser machining, electron beam machining, ion beam machining, ion etching, sputter etching, and plasma etching; chemical processes such as wet etching. Among these, physical processes are preferred because they can be performed easily under dry conditions, and laser machining is particularly preferred because it does not require vacuum or any special atmosphere. Laser machining is a method of machining that exploits thermal energy derived from the energy of laser, and is performed on a non-contact basis in the atmosphere with the workpiece heated locally. Especially preferred in the hue adjustment method according to the present invention is so-called laser trimming, whereby the surface of the phosphor layer is removed with a laser beam while the hue of the LED is being measured.

The LED element used in the present invention may be of any type, examples including blue LED elements such as those based on GaN; and red and green LED elements such as those based on GaAs, AlGaAs, AlGaInP, InP, or GaP.

The hue adjustment method according to the present invention is applicable not only to LEDs in the form of chips but also to LEDs in the form of lead frames. Moreover, the hue adjustment method according to the present invention is applicable to LEDs of any color.

### EXAMPLES

### Example 1

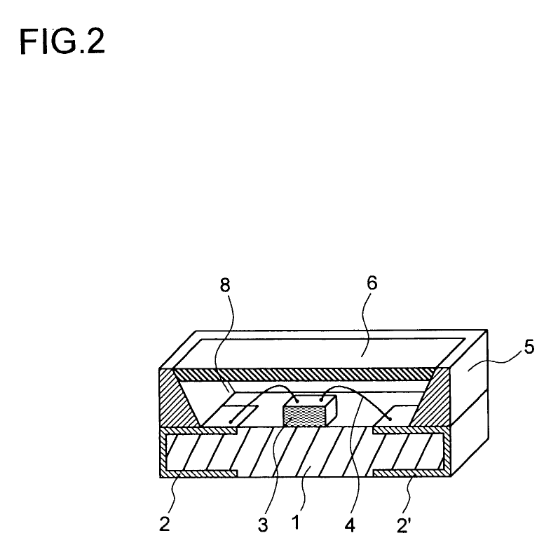

A sample LED as shown in FIG. 2 was produced in the following manner. First, a GaN-based LED element 3 was mounted on a chip substrate 1, then a reflector case 5 was fitted on the top surface of the chip substrate 1, and then the inside of the reflector case 5 was sealed with sealing resin 8. Then, translucent resin, having a Ce-activated, YAG-based phosphor (having an average particle diameter of 6 μm) dispersed therein, was applied on top of the sealing resin 8 to form a phosphor layer 6 (measuring 1.6 mm long, 2.3 mm wide, and 0.3 mm thick).

Hue Adjustment

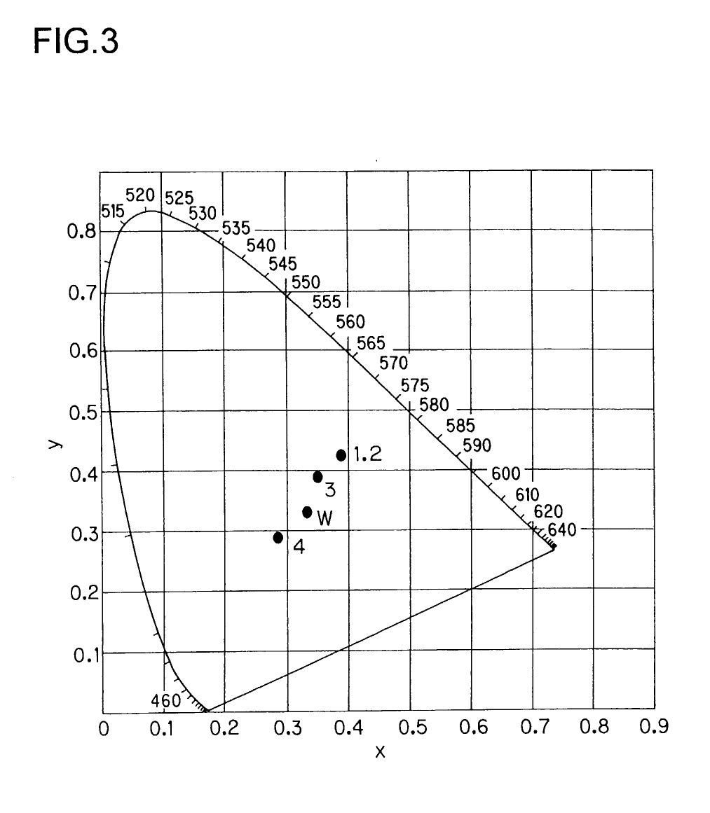

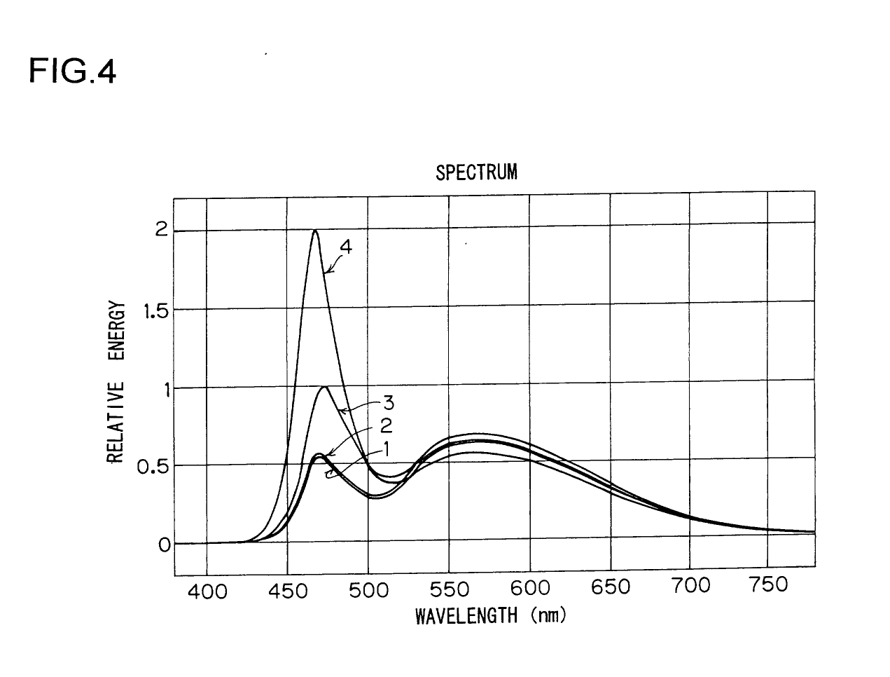

The phosphor layer 6 of the sample LED produced as described above was irradiated with a laser beam, and measurements were made of the amount of the portion of the phosphor layer 6 shaved off and the hue of the LED. The hue was measured with a model MCPD-3000 spectrophotometer manufactured by Otsuka Electronics Co., Ltd, Japan. The measurement results are shown in a chromaticity coordinates diagram in FIG. 3 and a spectrum diagram in FIG. 4.

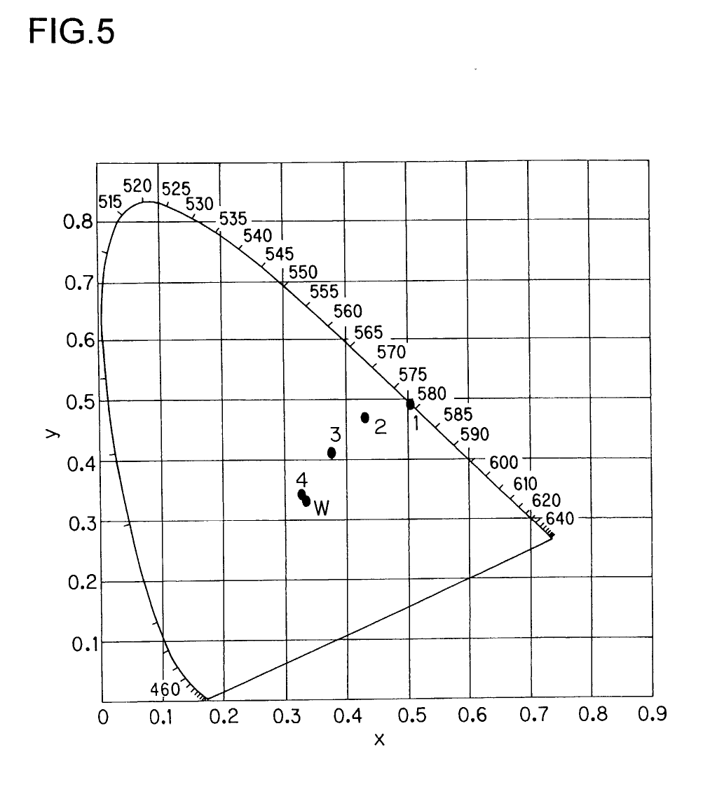

As will be clear from FIGS. 3 and 4, before the phosphor layer was shaved with a laser beam, the light emitted by the LED was yellow (No. 1). After 100 μm of the phosphor layer was shaved off, the emitted light was still yellow (No.2). After another 100 μm was shaved off, the emitted light was yellowish white (No. 3). After still another 50 μm was shaved off, the emitted light was bluish white (No. 4). In FIG. 3, the symbol W indicates the white region (the same applies also in FIG. 5). These results show that, to adjust the hue of this sample LED to white, it is necessary to shave off about an intermediate amount between No. 3 and No. 4, i.e. about 225 μm, of the phosphor layer.

### Example 2

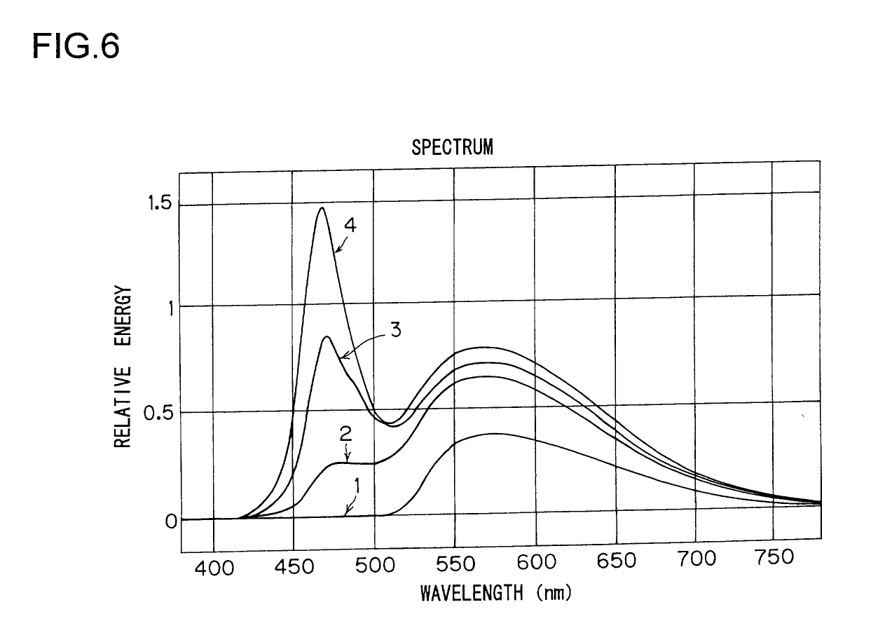

A sample LED was produced and its hue was adjusted in the same manner as in Example 1, except that here a phosphor having an average particle diameter of 2.5 μm was used. The measurement results are shown in a chromaticity coordinates diagram in FIG. 5 and a spectrum diagram in FIG. 6.

As will be clear from FIGS. 5 and 6, before the phosphor layer was shaved with a laser beam, the light emitted by the LED was reddish yellow (No. 1). After 100 μm of the phosphor layer was shaved off, the emitted light was yellow (No.2). After another 100 μm was shaved off, the emitted light was yellowish white (No. 3). After still another 50 μm was shaved off, the emitted light was white (No. 4).

What is claimed is:

1. A method for adjusting a hue of light emitted by a light-emitting diode, comprising the steps of:
laying a phosphor layer containing a phosphor on top of a translucent sealing resin having a light-emitting diode element sealed therein; and
adjusting a hue of emitted light by shaving the phosphor layer.

2. A method for adjusting a hue of light emitted by a light-emitting diode as claimed in claim 1,
wherein the phosphor layer is shaved by laser beam machining.

3. A method for adjusting a hue of light emitted by a light-emitting diode as claimed in claim 1,
wherein the method is used to adjust a hue of light emitted by a white light-emitting diode.

4. A method for adjusting a hue of light emitted by a light-emitting diode as claimed in claim 3,
wherein the light-emitting diode is based on GaN, and the phosphor is based on YAG activated by cerium.

5. A method for adjusting a hue of light emitted by a light-emitting diode as claimed in claim 1,
wherein the phosphor layer has a thickness in a range from 100 to 500 μm.
